(19) United States
(12) Patent Application Publication
(10) Pub. No.: US 2008/0238011 A1
(43) Pub. Date: Oct. 2, 2008

(54) Mobile article transporter

(76) Inventors: Howard Hammel, Springfield, IL (US); Lori Hammel, Springfield, IL (US); Kenneth Hammel, Springfield, IL (US); Sheryl Hammel, Springfield, IL (US)

Correspondence Address: ROBERT M. PATINO, 1901 S. PASFIELD, SPRINGFIELD, IL, 62704, US

(21) Appl. No.: 11/729,466

(22) Filed: Mar. 29, 2007

(51) Int. Cl. B62B 3/02

(52) U.S. Cl. 280/47.34

(57) ABSTRACT

A mobile article transporter for transporting items distances on a ground surface that has a set of expandable side panels supported on a corresponding set of rear side frame members to form a set of side walls that are moveable between an expanded position and a compressed position and further contains a collapsible inner support frame associated with the set of rear side frame members to support an at least one storage tray. The at least one storage tray is moveable at one end such that the at least one storage tray is able to sit substantially planarly parallel to a rear wall when in said folded position. The mobile article transporter may optionally be provided with a top cover that is retractable located above the at least one storage tray that provides a top shield to protect the items in an upper internal area of the mobile article transporter.

### BACKGROUND OF THE INVENTION

The invention relates to a mobile article transporter, and more specifically the invention relates to a mobile cart that is convenient for use at a variety of events preferably for multi-person groups that transports items securely with a minimal amount of effort for easing the need to haul items on one's person.

Parents of young children frequently use strollers or prams as a means of transporting their children around while at amusement parks, fairs, zoos, concerts and a variety of other events. For these parents, the stroller develops into an effective instrument to not only transport their young children around, but also to transport their own personal belongings. Families will spend several hours to full days at these events being able to use their strollers to store items bought or won at shops or carnival games while carrying their smallest children that might be too tired to walk. Outside events typically require families to bring coats, rain gear, blankets and other items that only need to be used during a portion of the event's activities. Families often find themselves bringing cameras, sunglasses, radios and more expensive items that are convenient to place on a stroller, but these items can become the targets of thieves if they are visible or easily accessible.

However, when the children become too old to use a stroller, parents often find themselves without their convenient transporting device and find that they either have to carry their items by hand or in an inconvenient carrying sack or bag that can add stress to the muscles and joints. Many families resort to renting out strollers or even wheel chairs at theme parks and fairs to ease the burden of transporting a multitude of items even when they do not have a family member in need of one. These families miss the convenience strollers were often able to provide to transport items. Parents also appreciate the ability of strollers being able to fold up into light weight, non-obtrusive bundles that could be carried with minimal difficulty and packed into small areas for convenient transportation or storage.

Several carts exist for transporting items, such as the traditional shopping cart or airport baggage carts, which are extremely bulky and heavy. Shopping carts and baggage carts were not designed for transporting items such as coats and small personal items. These large carts lack a means of compressing into small units, making them unattractive for portability because of the space they take up in the family vehicle. These open framed carts expose the contents they carry to the public, making expensive items possible targets to thieves.

Families and multi-person groups would benefit from an article transporter that is generally smaller and compressible into a smaller body for ease of transportation and portability. Existing smaller transporting carts lack necessary amenities that would make them suitable for public enjoyment. These amenities include a reliably sturdy body that is non-transparent and a locking mechanism to secure belongs in order to deter would be thieves. Smaller compressible bags also lack at least one solid surface which would make the transport device more durable and usable as a flat surface when at picnics and like events. U.S. Pat. No. 5,464,237 discloses a wheeled cart with opposing foldable walls that collapse into a hard surface; however this design requires parts to be removed when folding that can be lost or misplaced.

Small rolling frames that support a flexible bag do exist but have several draw backs. The interiors often lack a solid base on which heavy objects can be stored. Most of these rolling bags on wheels are often designed with one large storage chamber that can only be accessed by an access door or flap on a top surface, making it inconvenient to access items located at the bottom of piled items. The smaller, more flexible transporters also lack a means of securely staying in an open, upright position causing them to be susceptible to prematurely fold or collapse. Articles inside the transporter may become damaged if the transporter were to collapse prematurely. Furthermore, these small rolling frames lack a drink suspension tray that can accommodate open containers so that drinks may be placed. Families often find themselves drinking beverages on hot days that the traditional stroller or other type of shopping cart cannot easily accommodate.

Therefore, it is desired to have an article transporter that is light weight and compressible into a smaller, convenient portable size without requiring the user to remove any parts. It is further desired that such article transporter be non-transparent and provided with a locking means to deter thieves from attempting to steal articles from within. It is also desired to have an article transporter that is durable and provided with an access means such that articles at the bottom are easy to access. Moreover, it is desired that such an article transporter be lockable into its transporting position and provided with a drink suspension tray and cart handle.

Thus, based on the prior art and known designs, there is a need for an article transporter with at least one solid tray that can be compressed into a relatively flat, portable state. There is also a need to have an article transporter that, has a lockable front or rear access door for easy access to articles found in a storage area. There is also a need that such an article transporter be provided with amenities such as a locking mechanism and a drink suspension tray.

### SUMMARY OF THE INVENTION

The above-identified needs are addressed by the present mobile article transporter for transporting items distances on a ground surface. One feature of the present invention in the preferred embodiment is a collapsible inner support frame associated with a set of rear side frame members that preferably support an at least one storage tray. The collapsible inner support frame allows the mobile article transporter to reduce its overall volume for easy transport or storage when not being used to transport articles. The at least one storage tray is moveable at one end to sit substantially planarly parallel to a back end surface when in a folded position so that the mobile article transporter folds into a substantially flat, rectangular body. Another feature of the present invention is a top cover located above the at least one storage tray that provides a top shield to protect the items in an upper internal area of the mobile article transporter. The top cover is preferably retractable rotatably by a cover roll designed to retract the covering surface area of the top cover when rotated.

In a preferred embodiment, the rear wall is provided with a rear access door to provide access to a lower internal area within the mobile article transporter so that items located at the bottom of a pile of items can be easily accessed. A front wall can optionally be provided with a front access door to provide access to a lower internal area within the mobile article transporter. In both access door embodiments, a lock is provided to deter and help prevent possible thieves from gaining access to the lower internal area where important items may be stored. A cart handle is further provided that is associated with an outer surface of the rear wall to assist in propelling the mobile article transporter in a desired direction and can be modified to accommodate a drink support tray.

More specifically, a mobile article transporter is provided for transporting items distances on a ground surface that includes a set of expandable side panels supported on a corresponding set of rear side frame members to form a set of side walls, wherein the set of expandable side panels are moveable between an expanded position and a compressed position. A rear wall is positioned approximate to the set of rear side frame members such that the rear wall forms a back end surface to prevent articles from falling out when the mobile article transporter is advanced. A collapsible inner support frame is also provided that is associated with the set of rear side frame members, wherein the collapsible inner support frame supports an at least one storage tray that is moveable at one end to sit substantially planarly parallel to the back end surface when in a folded position. A front wall positioned near a forward end of the set of expandable side panels and a top cover located above the at least one storage tray are further provided to complete an enclosed body to transport articles.

In another embodiment, a mobile article transporter for transporting items distances on a ground surface is provided with a set of side panels supported on a corresponding set of rear side frame members to form a set of side walls, a rear wall positioned approximate to the set of rear side frame members, a front wall positioned near a forward end of the set of side panels, and a top cover located above an at least one storage tray that provides a top shield to protect the items in an upper internal area of the mobile article transporter. A plurality of cart wheels is further provided that are located approximate to a base portion for providing a plurality of moveable contact points on the ground surface and a cart handle is associated with the rear wall to assist in propelling the mobile article transporter in an advancing direction.

In yet another embodiment, a mobile article transporter for transporting items distances on a ground surface is provided with a top cover that is retractable rotatably by a cover roll and located above an at least one storage tray that provides a top shield to protect the items in an upper internal area of the mobile article transporter. The mobile article transporter is further provided with a set of side panels supported on a corresponding set of rear side frame members to form a set of side walls, a rear wall positioned approximate to the set of rear side frame members such that the rear wall forms a back end surface, an inner support frame associated with the set of rear side frame members, wherein the inner support frame supports the at least one storage tray, and a front wall positioned near a forward end of the set of side panels. A plurality of cart wheels is also provided and is located approximate to a base portion for providing a plurality of contact points to the ground surface.

### BRIEF DESCRIPTION OF THE DRAWINGS

The preferred embodiment of the invention will be described in reference to the accompanying drawings in which:

FIG. 1 is a disassembled front view perspective of a mobile article transporter provided with an upper storage tray, a lower storage tray and a set of expandable side panels;

FIG. 2 is a rear plan view of the mobile article transporter illustrating a locking mechanism;

FIG. 3 is a front perspective view of the mobile article transporter with a rear access door and a closed access top cover in an expanded position;

FIG. 4 is a front view of the mobile article transporter in a collapsed position; and

FIG. 5 is an alternative embodiment of the mobile article transporter with a front access door.

### DETAILED DESCRIPTION OF THE PREFERRED EMBODIMENT

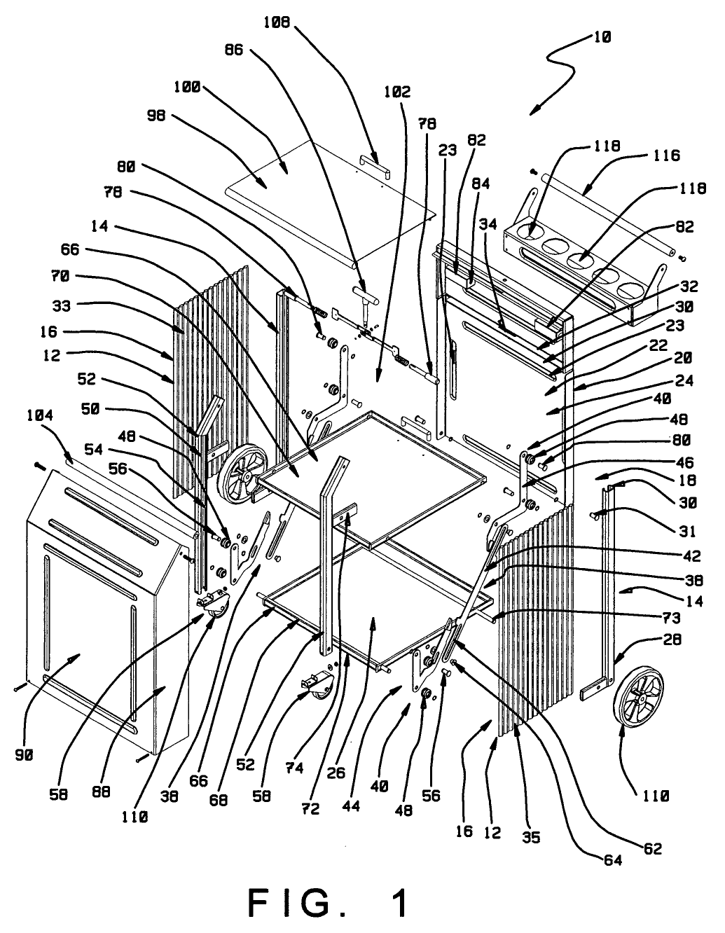

Referring now to FIG. 1, a mobile article transporter for transporting items distances on a ground surface is generally designated 10. The mobile article transporter 10 is provided with a set of side panels 12 supported on a corresponding set of rear side frame members 14 to form a set of side walls 16. The rear side frame members 14 are preferably located towards a back end 18 of the mobile article transporter 10 to assist in supporting a rear wall 20 positioned approximate to the set of rear side frame members 14 such that the rear wall 20 forms a back end surface 22. The rear wall 20 is made of a durable material that is resistant to common wear and dings that are typically encountered when a cart-like vehicle is moved or other moving objects come into contact with the rear wall 20 itself. The rear wall 20 is also provided with stiffners 23 to enhance the durability of the rear wall 20 which are commonly employed in conjunction with injection molding techniques.

In the preferred embodiment, the rear wall 20 is provided with a rear access door 24 to provide access to a lower internal area 26 within the mobile article transporter 10. The rear access door 24 is pivotally attached to a lower portion 28 of the set of rear side frame members 14 so that the rear access door 24 might be opened at a top end 30 of the rear access door 24 and made to pivot downward by a pair of door pivot pins 31. However, it is contemplated that the rear access door 24 might also be attached by pivotally or hingedly attaching itself to only one member of the rear side frame members 14 to open sideways. Alternatively, the rear access door 24 may be pivotally or hingedly attached to an upper portion 32 of the rear wall 20 so that the rear access door 24 pivots in an upward manner. It is well understood that any number of other means used to attach the rear access door 24 well known in the art may be employed for access to the lower internal area 26.

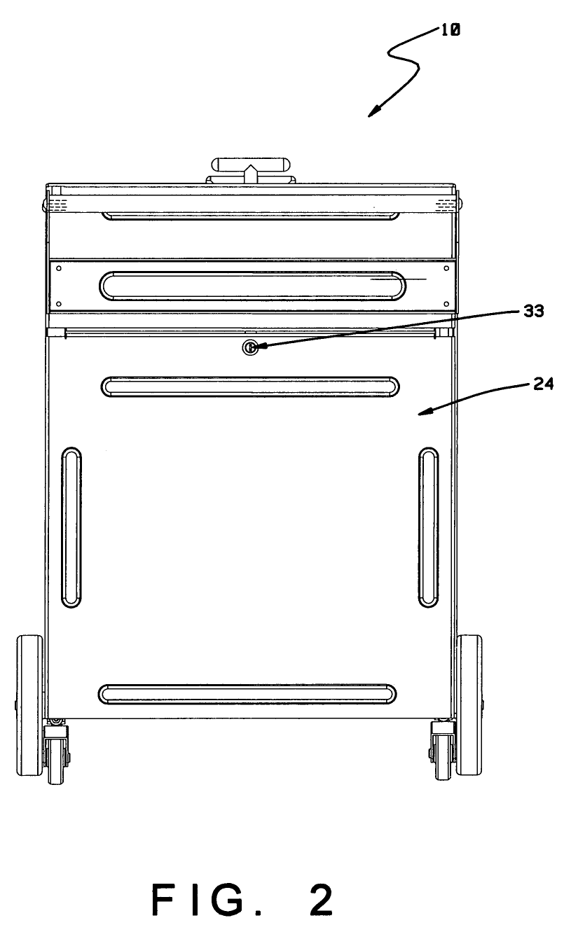

Now referring to FIGS. 1 and 2, in the most preferred embodiment, the rear access door 24 is further provided with a locking mechanism 33 to secure the rear access door 24 to the rear wall 20 to inhibit thieves from easily accessing the articles found within the lower internal area 26. A simple key or combination code (not shown) can be used to open the locking mechanism 33 depending on the type of lock incorporated into the design. In the present embodiment, a key designed to couple with the locking mechanism 33 is inserted into the locking mechanism 33 and rotated to release a securement lever (not shown) fed through a locking lever slit 34 until the rear access door 24 can be rotated open without any or minimal obstruction from the securement lever.

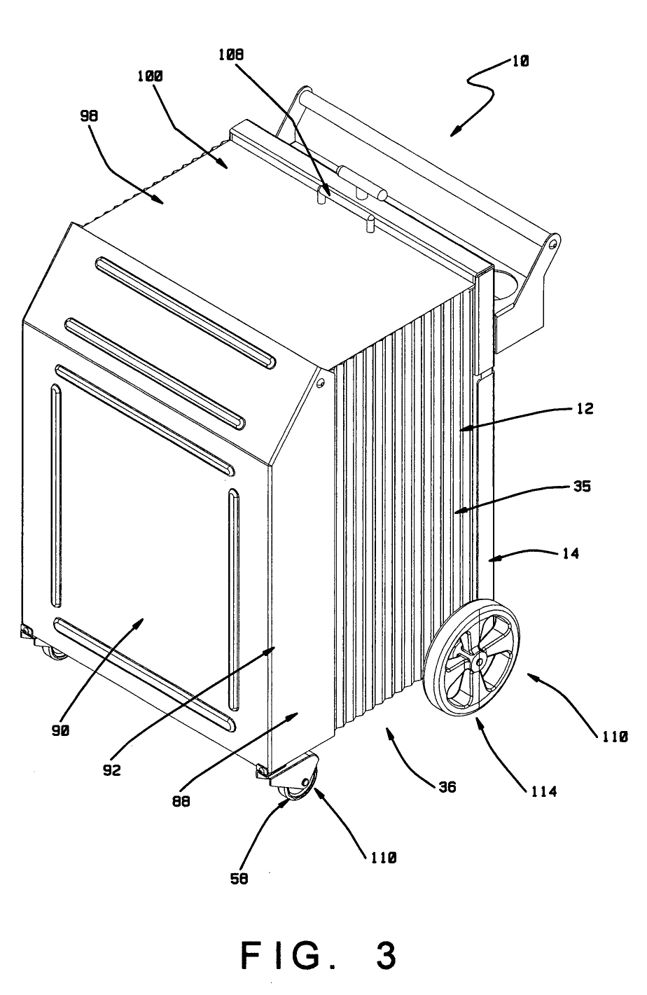

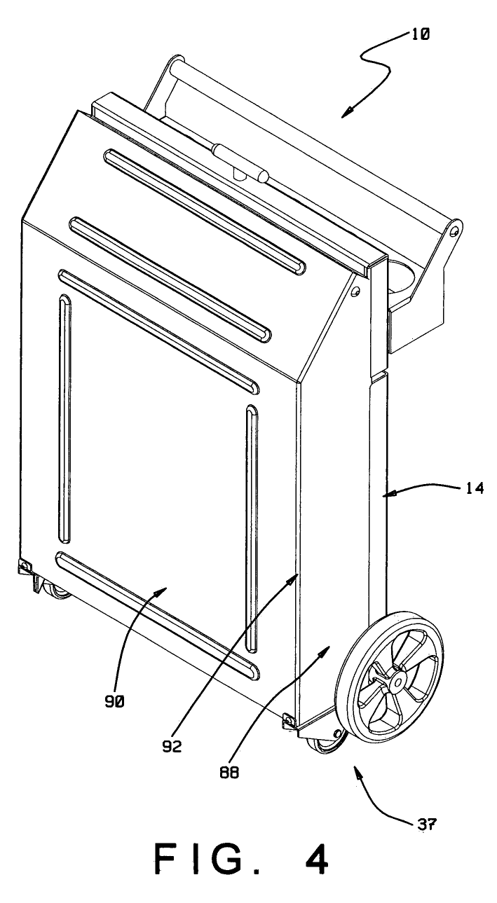

Now referring to FIGS. 1, 3 and 4, in the most preferred embodiment, the set of side panels 12 are a set of expandable side panels 35 that are moveable between an expanded position 36 (as shown in FIG. 3) and a compressed position 37 (as shown in FIG. 4). The moving action of the expandable side panels 35 is achievable principally because of a collapsible inner support frame 38 associated with the set of rear side frame members 14. The collapsible inner support frame 38 is most preferably provided with opposing pairs of slideable runners 40 designed to move freely in a vertical manner on a complimentary side frame member. A support bar 42 connects a front slideable runner 44 with a rear slideable runner 46. The slideable runners 40 are provided with an at least one running wheel 48 that fits inescapably in a corresponding running track 50 that is located on the rear side frame member 14 or a front side frame member 52. The inescapability is created by leaving an open gap 54 that runs vertically along an internal side of the respective side frame member. The open gap 54 is sufficiently wide to receive an axle 56 of the at least one running wheel 48 but is sufficiently narrow to prevent the at least one running wheel 48 from slipping out. Obstructions exist at exit points on the side frame member such as a transport wheel 58 or a bent solid portion of the front side frame member 52 to prevent the slideable runner 40 from exiting out from the exit points. It is also appreciated that the slideable runners 40 might also incorporate slideable bars or like object instead of the at least one running wheel 48 to achieve substantially the same function.

The support bar 42 connects the front slideable runner 44 and the rear slideable runner 46 in an angular manner when the mobile article transporter 10 is in the expanded position 36. The support bar 42 is provided with an at least one slack groove 62 to allow the slideable runners 40 to move vertically along the rear side frame member 14 or the front side frame member 52 unobstructively while still remaining intimately attached to one another. Each slideable runner 40 is attached to the at least one slack groove 62 by a slideable pin 64. This arrangement provides concurrent movement of the slideable runners 40 while providing stability to the structure of the mobile article transporter 10 when the mobile article transporter 10 is moved between the compressed position 37 to the expanded position 36.

Now referring to FIGS. 1 and 4, the collapsible inner support frame 38 supports an at least one storage tray 66 that is moveable at one end to sit substantially planarly parallel to the back end surface 22 when in a folded position (as shown in FIG. 4). In the event that only one storage tray 66 is utilized, only one set of slideable runners 40 is needed. However, in the most preferred embodiment, two storage trays 66 are used that comprise of a lower storage tray 68 and an upper storage tray 70, wherein the upper storage tray 70 of the at least one storage tray 66 resides substantially planarly parallel above the lower storage tray 68. The lower storage tray 68 and the upper storage tray 70 are preferably rectangularly shaped to substantially match the overall planar configuration of the mobile article transporter 10 as seen from a bottom plan view (not shown) in the expanded position 36. The lower storage tray 68 of the at least one storage tray 66 presides as a base portion 72 pivotally attached to a lower portion 28 of the set of rear side frame members 14 by an extended rounded protrusion 73 that extends horizontally from the base portion 72.

The upper storage tray 70 is pivotally attached to an extended segment 74 of the front side frame member 52. The extended segment 74 protrudes slightly rearwardly towards the rear wall 20 so as to not interfere with the movement of the slideable runners 40. The upper storage tray 70 is further provided with a tray handle 76 to assist with movement of the upper storage tray 70. The tray handle 76 aids the user of the mobile article transporter 10 to push or pull the upper storage tray 70 in an up or down manner to make it easier for the mobile article transporter 10 to be moved from the compressed position 37 to the expanded position 36. The upper storage tray 70 is pushed downwardly on a side where the tray handle 76 resides to collapse the mobile article transporter 10 and is preferably pulled upwardly by the tray handle 76 to expand the mobile article transport 10 until it resides in the expanded position 36. The space between the upper storage tray 70 and the lower storage tray 68 is defined as the lower internal area 27; however, more generally, the lower internal area 27 is defined as an area accessible by the rear access door 24 that is support by the base portion 72.

A means of securing the mobile article transporter 10 in the expanded position 36 is provided by a removable pair of hollow ended locking pins 78. The removable pair of hollow ended locking pins 78 feed into a tapered receiving pin 80 that secures the at least one running wheel 48 to the rear slideable runner 46 used to assist the collapse of the collapsible inner support frame 38. The removable pair of hollow ended locking pins 78 are spring loaded and sit snuggly into a corresponding set of placement boxes 82 that have a retainment hole 84 borrowed through to accommodate the removable pair of hollow ended locking pins 78. A release lever 86 is provided to disengage the removable pair of hollow ended locking pins 78 through a pulling action that moves the removable pair of hollow ended locking pins 78 inwardly sufficiently to escape the tapered receiving pin 80 and allowing the rear slideable runner 46 to move freely in a downward position.

Now referring to FIGS. 1, 3 and 4, the set of expandable side panels 35 are preferably collapsible in an accordion-like or folding-like manner such that the set of side walls 16 are of a smaller surface area (as shown in FIG. 4) when in the compressed position 37 than when extended in the expanded position 36 (as shown in FIG. 3). The set of expandable side panels 35 compress comfortably into an area defined by the extended segment 74 of the front side frame member 52, the front side frame member 52 and the rear side frame member 14, and is protected by a side covering 88. The side covering 88 couples rearwardly from a front wall 90 positioned near a forward end 92 of the side covering 88. When the set of expandable side panels 35 reside in the expanded position 36, the set of expandable side panels 35 shield the articles within the mobile article transporter 10 from elements in the outside environment while providing a safe enclosure to deter perspective thieves. Accordion walls may be made of wood, plastics or other materials well known in the art and do not require an upper or lower support beam to maintain the integrity of its upstanding configuration. The accordion walls of the present invention are attached to the set of rear side frame members 14 and the front side frame member 52,

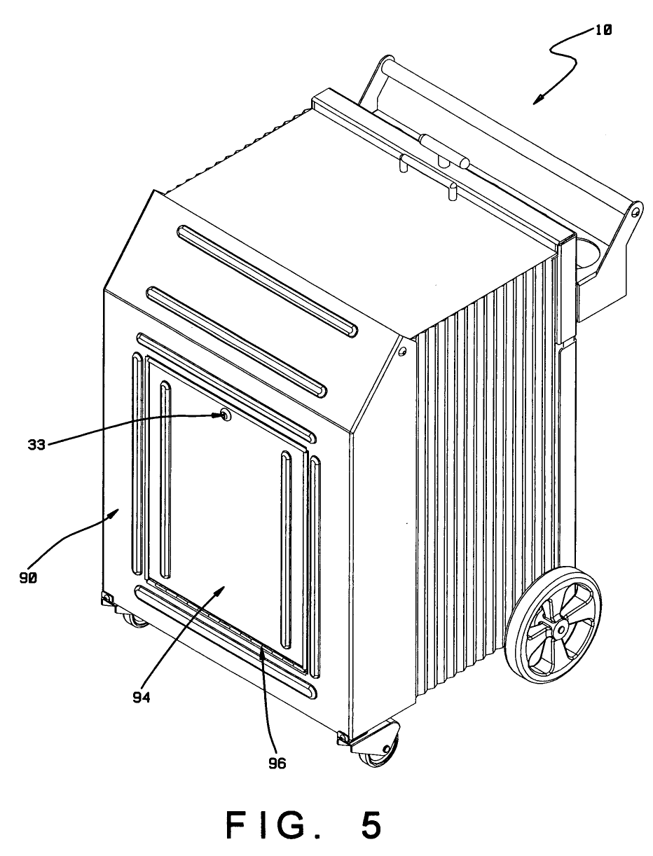

Now referring to FIG. 5, in an alternative embodiment, the front wall 90 is provided with a front access door 94 to provide access to the lower internal area 26 within the mobile article transporter 10. The front access door 94 is also provided with a locking mechanism 33 to secure the articles found within the lower internal area 26. The front access door 94 can be used to compliment the rear access door 24 or act as a substitution depending on user preference. The front access door 94 is hingedly attached by a piano hinge 96 to assist in the pivoting action of the front access door 94.

Now referring to FIGS. 1 and 3, a top cover 98 is preferably provided above the at least one storage tray 66 that provides a top shield 100 to protect the items in an upper internal area 102 of the mobile article transporter 10. In the most preferred embodiment, the upper internal area 102 is between the top cover 98 and the upper storage tray 70 so that the upper storage tray 70 may be used as a second chamber for storing items or articles the top cover 98. However, more generally, the upper internal area 102 is defined as an area within the mobile article transporter 10 that may be accessible when the top cover 98 is open. In the event that the upper storage tray 70 is not used, the upper internal area 102 is expanded to cover the area between the base portion 72 and the top cover 98.

In the most preferred embodiment, the top cover 98 is retractable rotatably by a cover roll 104 designed to retract a covering surface area 106 of the top cover 98 when rotated. The cover roll 104 enables a user to quickly access less valuable or bulky items without looking for a key and bending down to access that item. The top cover 98 is also provided with a cover handle 108 to assist with the opening and closing of the top cover 98. The cover roll 104 also is provided with a spring action retract system that is well known in the art that allows the top cover 98 to be extracted to a desired covering length and kept in place. Upon a quick jerking action, the spring action retract system will recoil the top cover 98 up to the cover handle 108 and neatly roll into a small, compact bundle that will allow the mobile article transporter to be condensed into the compressed position 37 similar to roller blinds used as curtains.

A plurality of cart wheels 110 is further provided and located approximate to the base portion 72 for providing a plurality of contact points to the ground surface. The at least one forward cart wheel 58 is preferably swivel in design to help direct turning movements of the mobile article transporter 10 when pushed in a forward or reverse manner. The at least one forward cart wheel 58 also aids in keeping the front slideable runner 44 from exiting downwardly from the open gap 54. An at least one rear cart wheel 114 is provided to complete the balancing requirement of having the mobile article transporter 10 level with the aid of cart wheels 110 and is preferably attached to the set of rear side frame members 14. The at least one rear cart wheel 114 is generally larger in diameter than the at least one forward cart wheel 58 to help propel the mobile article transporter 10 over obstacles such as sidewalk curbs, pot holes and debris just to name a few examples.

A cart handle 116 is associated with the rear wall 20 to assist in propelling the mobile article transporter in a planar direction relative to the ground surface. The cart handle 116 is most preferably situated near the upper portion 32 of the rear wall 20 so that the average adult person can push or pull the mobile article transporter 10 by pushing or pulling the cart handle 116 without bending to reach it. The cart handle 116 generally extends backwards and upwards towards the user and is substantially as wide as rear wall 20. In the most preferred embodiment, a plurality of cup holders 118 are molded into the cart handle 116 to serve as a drink holding tray that would otherwise require a person to carry a drink by hand. Holding a drink and pushing a cart at the same time can be a challenging task for one person. Optionally, drink baskets or other forms of cup holders 118 may be used to achieve the same functionality similar to a drink suspension tray. The convenience of the plurality of cup holders 118 also gives the additional benefit of supporting multiple drinks while children or other persons may partake in a physical or miscellaneous activity without having to leave their drinks on the ground or to the mercy of a strong wind.

While a particular embodiment of the mobile article transporter has been described herein, it will be appreciated by those skilled in the art that changes and modifications may be made thereto without departing from the invention in its broader aspects and as set forth in the following claims.

I claim:

1) A mobile article transporter for transporting items distances on a ground surface, comprising:
a set of expandable side panels supported on a corresponding set of rear side frame members to form a set of side walls, wherein said set of expandable side panels are moveable between an expanded position and a compressed position;
a rear wall positioned approximate to said set of rear side frame members such that said rear wall forms a back end surface;
a collapsible inner support frame associated with said set of rear side frame members, wherein said collapsible inner support frame supports an at least one storage tray that is moveable at one end to sit substantially planarly parallel to said back end surface when in a folded position;
a front wall positioned near a forward end of said set of expandable side panels; and
a top cover located above said at least one storage tray that provides a top shield to protect the items in an upper internal area of the mobile article transporter.

2) The mobile article transporter of claim 1, wherein a plurality of cart wheels is further provided and located approximate to a base portion for providing a plurality of contact points to the ground surface.

3) The mobile article transporter of claim 1, wherein said set of expandable side panels are collapsible in an accordion-like manner such that said set of side walls are of a smaller surface area when in said compressed position than when extended in said expanded position.

4) The mobile article transporter of claim 1, wherein said rear wall is provided with a rear access door to provide access to a lower internal area within the mobile article transporter.

5) The mobile article transporter of claim 4, wherein said rear access door is pivotally attached to said set of rear side frame members.

6) The mobile article transporter of claim 4, wherein said rear access door is further provided with a locking mechanism to secure said rear access door to said rear wall.

7) The mobile article transporter of claim 1, wherein a release lever is further provided to disengage a means of securing the mobile article transporter in said expanded position.

8) The mobile article transporter of claim 7, wherein the means of securing the mobile article transporter in said expanded position is provided by a removable pair of hollow ended locking pins feeding into a tapered receiving pin of a rear slideable runner used to assist the collapse of said collapsible inner support frame.

9) The mobile article transporter of claim 1, wherein a cart handle is associated with said rear wall to assist in propelling the mobile article transporter in a planar direction relative to the ground surface.

10) The mobile article transporter of claim 1, wherein a lower storage tray of said at least one storage tray presides as a base portion attached to a lower portion of said set of rear side frame members.

11) The mobile article transporter of claim 10, wherein an upper storage tray of said at least one storage tray resides substantially planarly parallel above said lower storage tray.

12) The mobile article transporter of claim 11, wherein said upper storage tray is further provided with a tray handle to assist with movement of said upper storage tray.

13) The mobile article transporter of claim 1, wherein said collapsible inner support frame is assisted to collapse by an at least one pair of slideable runners guided by a corresponding running track.

14) The mobile article transporter of claim 1, wherein said front wall is provided with a front access door to provide access to a lower internal area within the mobile article transporter.

15) The mobile article transporter of claim 1, wherein said top cover is retractable rotatably by a cover roll designed to retract a covering surface area of said top cover when rotated.

16) A mobile article transporter for transporting items distances on a ground surface, comprising:
a set of side panels supported on a corresponding set of rear side frame members to form a set of side walls;
a rear wall positioned approximate to said set of rear side frame members such that said rear wall forms a back end surface;
an inner support frame associated with said set of rear side frame members, wherein said inner support frame supports an at least one storage tray;
a front wall positioned near a forward end of said set of side panels;
a top cover located above said at least one storage tray that provides a top shield to protect the items in an upper internal area of the mobile article transporter;
a plurality of cart wheels located approximate to a base portion for providing a plurality of contact points to the ground surface; and
a cart handle associated with said rear wall to assist in propelling the mobile article transporter in a planar direction relative to the ground surface.

17) The mobile article transporter of claim 16, wherein said rear wall is provided with a rear access door to provide access to a lower internal area within the mobile article transporter.

18) The mobile article transporter of claim 16, wherein said front wall is provided with a front access door to provide access to a lower internal area within the mobile article transporter.

19) The mobile article transporter of claim 16, wherein said at least one storage tray further comprises of a lower storage tray and an upper storage tray for storing items below said top cover.

20) A mobile article transporter for transporting items distances on a ground surface, comprising:
a set of side panels supported on a corresponding set of rear side frame members to form a set of side walls;
a rear wall positioned approximate to said set of rear side frame members such that said rear wall forms a back end surface;
an inner support frame associated with said set of rear side frame members, wherein said inner support frame supports an at least one storage tray;
a front wall positioned near a forward end of said set of side panels;
a plurality of cart wheels located approximate to a base portion for providing a plurality of contact points to the ground surface; and
an access top cover located above said at least one storage tray that provides a top shield to protect the items in an upper internal area of the mobile article transporter, wherein said top cover is retractable rotatably by a cover roll designed to retract a covering surface area of said top cover when rotated.
